(19) United States
(12) Patent Application Publication
(10) Pub. No.: US 2016/0081318 A1
(43) Pub. Date: Mar. 24, 2016

(54) Fishing Tackle Knot Funnel Body

(71) Applicant: Russell Rothan, Chicago, IL (US)

(72) Inventor: Russell Rothan, Chicago, IL (US)

(21) Appl. No.: 14/957,993

(22) Filed: Dec. 3, 2015

Related U.S. Application Data
(63) Continuation of application No. 13/548,605, filed on Jul. 13, 2012, now abandoned.

(51) Int. Cl. A01K 91/04

(52) U.S. Cl. CPC A01K 91/04

(57) ABSTRACT

An connection apparatus for fishing tackle that is adapted to allow the securement of the apparatus to a fishing line by the half-hitch, overhand knot or any other low dexterity knot through the use of a dual conical, hourglass shaped bore passing through the main body of the apparatus. The apparatus has a main body having a solid walled, dual tapered bore formed there through with an open able connection device such as split ring that extends at an angle from the linear axis of the main body. The device eliminates the need for any further fishing gear to connect a lure to a fishing line.

### RELATED APPLICATIONS

This patent incorporates by reference the entirety of, and claims priority under the benefit under Title 35, United States Code, §120 of the U.S. utility patent application Ser. No. 13/548,605 filed on Jul. 13, 2012 and entitled “Fishing Tackle Knot Funnel Body” which claims priority under the benefit under Title 35, United States Code, §119(e) of the U.S. provisional patent application Ser. No. 61/508,194 filed on Jul. 15, 2011 and entitled “Fishing Tackle Knot Funnel.”

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present invention relates generally to a new and novel device for simply securing and releasing a fishing line that has applications for all users, however is targeted for those users with reduced dexterity in their fingers as is common with older fishermen, arthritic fishermen or fishermen in cold climates.

### BACKGROUND

The present invention relates to an extremely compact fishing tackle device that will simply allow for the connection of at least one fishing line in a quick-to-fasten and quick-to-release fashion that is adapted to provide both speed and convenience for the user. More particularly, to a fishing tackle device allowing a secure connection to at least one fishing line through the use of a simple knot whether it be a half-hitch, an overhand knot or another low dexterity, non complex knot. This device is secure enough connect the most expensive of lures without fear of loss, but for a broken fishing line.

The American populace is aging but living longer. Along with this comes avid sportsmen fishing well into their golden years. Many of those older fishermen no longer have the dexterity in their fingers to tie the minute and complicated knots that fishing tackle requires such as Albright knots, Eye Crosser Knots, Surgeons End Loops and the like. Anyone that has ice fished for any length of time can also attest to the lack of digit dexterity in the colder climates. As is with many of the very young fishermen that are blessed with small hands and ample dexterity, learning to tie fishing knots is often an arduous process. With all of the aforementioned examples, there are often problems encountered when trying to secure fishing line to an article of fishing tackle. All this said, the difficulty of tying the knot is only half of the problem. Once the knot is tied, releasing it is often an extended process.

Henceforth, a simple, quick and secure device to tie and untie at least one fishing line from an article of fishing tackle would fulfill a long felt need in the fishing industry. This new invention utilizes and combines known and new technologies in a unique and novel configuration to overcome the aforementioned problems and accomplish this.

### BRIEF SUMMARY

In accordance with various embodiments, a fishing tackle body with at least one knot funnel bore formed therein is provided. More specifically, an apparatus or specially designed body to allow secure connection between many kinds of fishing tackle and lines with a simple knot. The general purpose of the present invention, which will be described subsequently in greater detail, is to provide a fishing tackle body that is capable of quick, simple and secure affixation to at least one fishing line. It can eliminate intermediary elements between the fishing line and the lure, such as leaders. It is also utilizes an open able circular coupling device to allow connection to a plethors of tackle items. It has many of the advantages mentioned heretofore and many novel features that result in a new fishing tackle body which is not anticipated, rendered obvious, suggested, or even implied by any of the prior art, either alone or in any combination thereof

In accordance with the invention, an object of the present invention is to provide an improved article of fishing tackle capable of simple connection to at least one fishing line.

It is a further object of this invention to provide an improved article of fishing tackle capable of allowing connection between a fishing line and at least one fishing tackle device such as a bobber, lure or other line.

It is still a further object of this invention to prevent the loss of fish from poorly tied knots.

It is a further object of the present invention to provide a fishing line connection device that is simple to thread and does not require knowledge of complex knots, so as to allow a user to change lures and tackle faster than with standard lures and tackle.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a bottom perspective view of an embodiment of a fishing tackle knot funnel body with a knotted fishing line attached therein;

FIG. 2 is a top view of an embodiment of an embodiment of a fishing tackle knot funnel body;

FIG. 3 is a side cross sectional view of an embodiment of a fishing tackle knot funnel body;

FIG. 4 is a top view of an embodiment of a fishing tackle knot funnel body with a knotted fishing line therein;

FIG. 5 is a top cross sectional view of an embodiment of a fishing tackle knot funnel body with a knotted fishing line therein;

FIG. 6 is a side perspective view of an embodiment of a fishing tackle knot funnel body coupled to a fishing line and a lure;

FIG. 7 is a side cutaway view of an embodiment of a fishing tackle knot funnel body showing the linear axis A of the block section; and

FIG. 8 is a side view of an embodiment of a fishing tackle knot funnel body showing the linear axis of the connector projection.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As used herein, the term “fishing tackle” refers to the grouping of fishing devices that are commonly affixed in some manner to a fishing line either directly or indirectly through coupling to other articles of fishing tackle.

As used herein, the term “transition region” refers to the point or length of bore in the block section of the fishing tackle knot funnel body that connects the top funnel bore and bottom funnel bore so as to form a through bore from the top face to the bottom face of the block section.

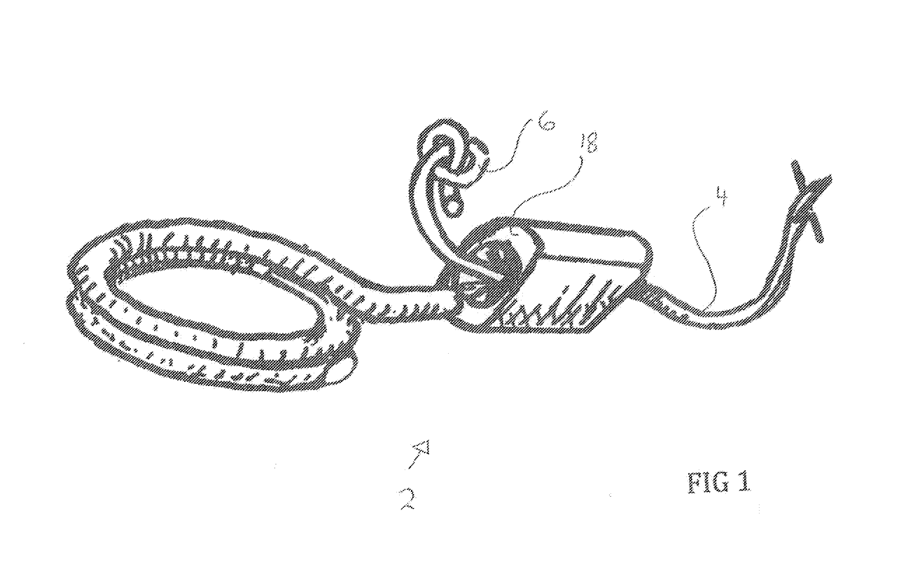

Looking at FIG. 1, it can be seen that the present invention, a fishing knot tackle body 2 (“funnel body”) is a unitary piece of fishing tackle made of a block section 12 and a connector projection 8 that extends therefrom the block section 12. The block section 12 has a pair of knot funnel bores formed there through that accommodate fishing line 4 securely to the funnel body 2 with but the tying of a simple knot 6 at the end of the fishing line that has been passed through and extends beyond the bottom funnel bore. The top knot funnel bore serves to allow the simple threading of the fishing line through the device and the bottom knot funnel bore cinches and retains the knot.

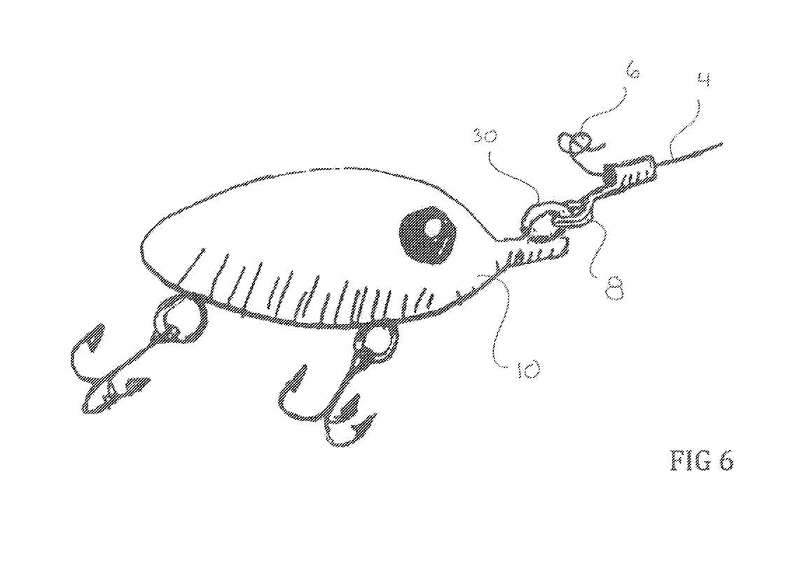

The funnel body 2 may be directly coupled to any piece of fishing tackle, or to another substantially similar funnel body 2. Leaders or additional split rings or open able couplers are not necessary. A simple orifice will suffice. FIG. 6 is a cross sectional view of a funnel body 2 with fishing line 4 threaded there through and a fishing lure 10 connected directly to the funnel body 2 by the connector projection 8, without any intervening tackle (such as a lure), illustrating the funnel body 2 in a typical application.

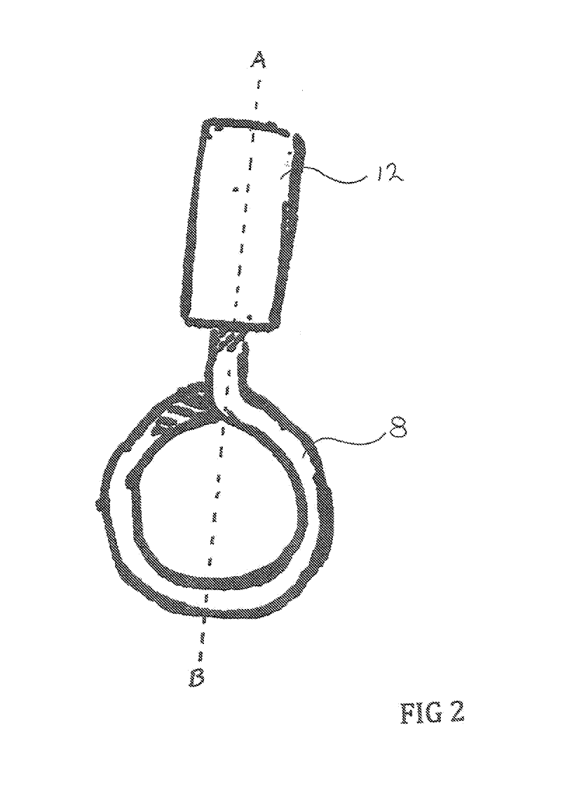

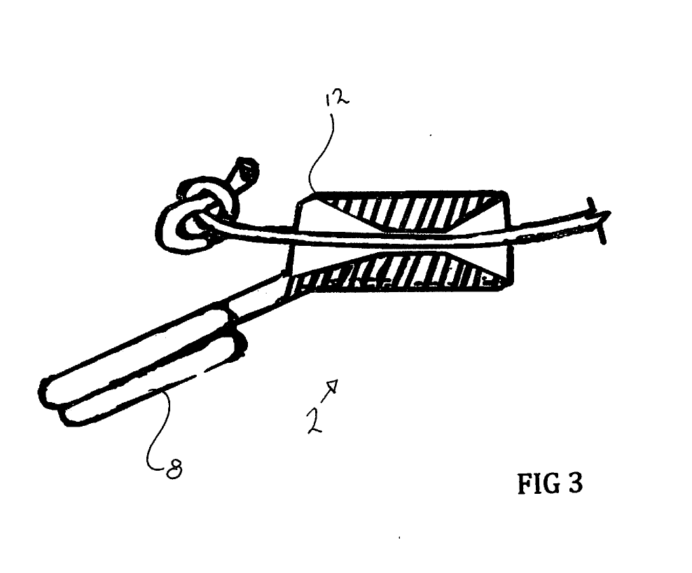

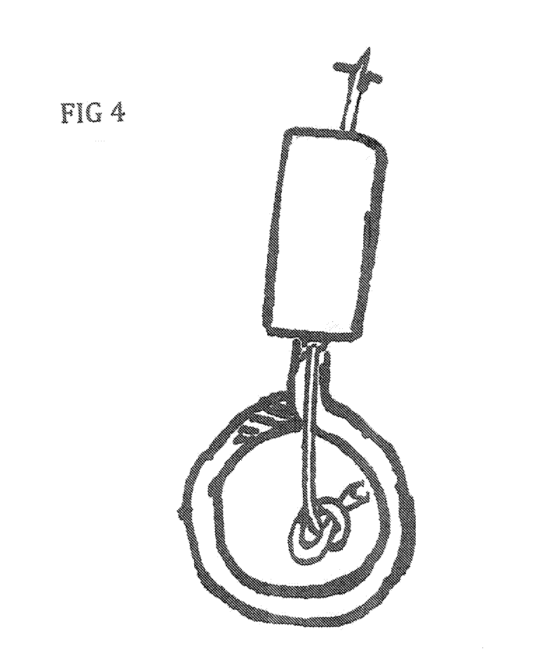

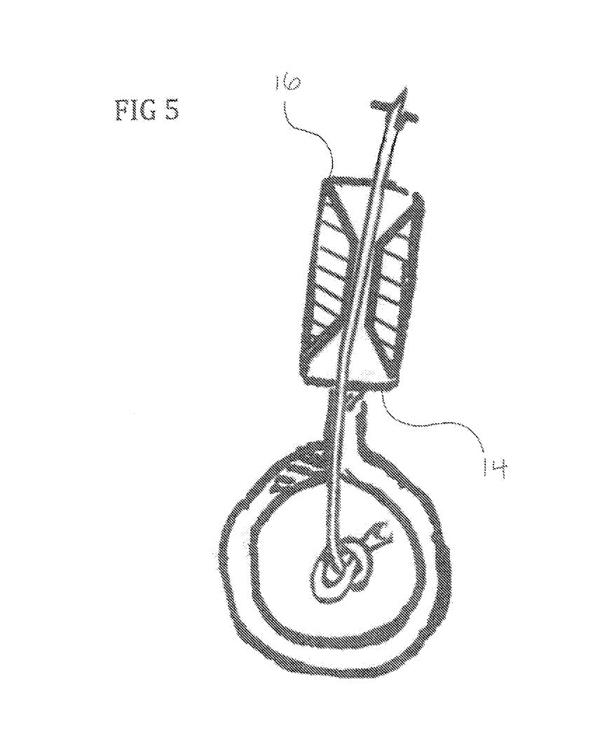

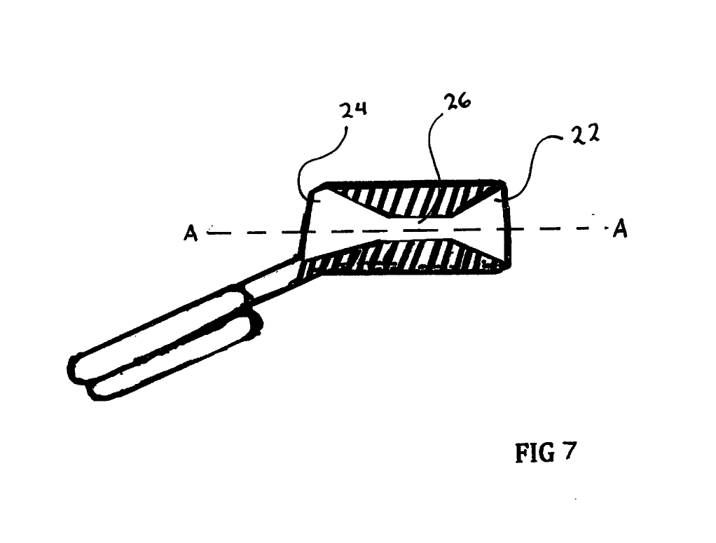

Looking at FIGS. 2-5 it can be seen that the funnel body 2 is a unitary piece having a block section 12 and a connector projection 8. The block section 12 has a distal end 14 and a proximal end 16. The block section 12 is a solid, linear body, generally cylindrical in shape. The block section 12 has a linear axis indicated by line A on FIG. 7, that passes through the linear centers of a top funnel bore 22, a transition region 26 and a bottom funnel bore 24 as well as through the block section's center of mass.

The block section 12 has a generally planar top face (not illustrated) at its proximal end 16, and a generally planar bottom face 18 at its distal end 14. These top and bottom faces reside generally parallel at the ends of the block section 12. There is a complete, uninterrupted 360 degree side wall, frusticonical (right cone or funnel shaped) top bore 22 formed beginning at the top face, and that tapers inward toward the center of the block section 12. There is also a complete, uninterrupted 360 degree side wall, frusticonical bottom bore 24 formed beginning at the bottom face 18, and that tapers inward toward the center of the block section 12. These “funnel” bores meet at the transition region 26. The length of the transition region 26 along the linear axis of the block section is variable and it may, at its minimum, merely be a point of intersection (and interface) between the two funnel bores. The top funnel bore 22 has its largest diameter at its circular entrance opening in the top face. The bottom funnel bore 24 has its largest diameter at its circular exit opening on the bottom face 18.

It is important that the funnel bores each have uninterrupted side walls free of openings in the block section 12. It is this total 360 degree side wall encapsulation that cinches tight the knot that is tied in the fishing line 4 that extends beyond the bottom funnel bore 24 once the fishing line is drawn upward and tensioned toward the transition region 26. It is this feature that allows for the simplest of knots to be tightly tied to secure the fishing line 4 to the funnel body 2 and yet allow for the quick release of the funnel body 2 from the fishing line 4. The 360 degree frictional engagement of the funnel bore's side walls about the perimeter of the knot 6 also provide even tension forces about the entire knot 6 preventing it from slipping apart under load or deforming to allow it to pass through the transition region 26.

Any break in the continuous, 360 degree side walls of the funnel bores such as slotted side opening, cannot be tolerated as it can allow the fishing line 4 to slip out and create a stress point to sever the fishing line 4. The fishing line should at all times when under tension, be centered and in direct alignment with the load it is experiencing. This uninterrupted wall feature ensures this. The fishing line has its greatest fighting strength when in direct alignment rather than on an angle.

The relationship of the dimensions of the various openings and transition region 26 is critical. It is known that the knot of a simply knotted line, regardless of the amount of compression or tightening, never decreases in size to twice the diameter of the unknotted region of the same fishing line.

The transition region 26 has a diameter large enough to accommodate an unknotted fishing line 4 yet smaller than twice the diameter of the same unknotted fishing line 4. The entrance opening and the exit opening have diameters greater than twice the diameter of the same unknotted fishing line 4. Since the knotted region of the fishing line 6 exceeds twice the diameter of an unknotted fishing line, once the unknotted fishing line is fed through the block section 12 and knotted, it cannot be pass through the transition region 26 and the top funnel bore 22.

With the connector projection 8 directly coupled to the dual funnel bored block section 12, the fishing line need only pass through the transition region 26 once, not twice as is necessary with other tackle connectors that have to also secure their connection device to their main body. This allows for four distinct advantages: smaller overall body profiles, smaller diameter transition regions 26, smaller funnel bores, and single knot tying. (Rather than complex or double knots to avoid slipping through their double fishing line width transition regions.)

In the preferred embodiment the top funnel bore 22 and the bottom funnel bore 24 are of identical dimensions, although in specialty situations this need not be the case. All of the edges occurring at the interfaces of the top face and bottom faces with the funnel bores, and at the interface of the funnel bores and the transition region 26, are rounded or radiused slightly to reduce stress points. With this rounding there is no need to make the block section 12 flexible to avoid line breakage. This is important as flexibility in the block section 12 can cause bending at the transition region 26 causing its circular cross section to deform or distort into an oval cross section, therein allowing the knot to slip through. The device should be a rigid as possible.

It is notable that with the funnel body 2, the connector projection 8 is an open able, circular coupling device. In the preferred embodiment a circular split ring is utilized. It has the ability to open so as to allow or accept coupling to solid rings, eyelets or even orifices as are commonly found drilled in the top of lures. In this way, even if there is no swivel ring or eyelet on the piece of fishing tackle it may still be coupled to the funnel body 2 via the open able connector projection and it will be capable of movement with respect to the coupling device 8 such twisting or sliding about the circular split ring. The funnel body 2 thus eliminates the need for fishing leaders as it can directly connect to a lure's ring 30 as illustrated in FIG. 6.

In lieu of an open able split ring that allows a direct connection to a fishing lure, the connector projection 8 may utilize another style of open able connector as would be well known in the industry.

With the present design, the connector projection 8 and the block section 12 are inseparably connected and cannot get lost unlike other fishing tackle combinations. The connector projection 8 has an arm that projects into the block section 12 and can be secured therein by mechanical means or chemical means, utilizing such techniques as threading, gluing, crimping, welding or brazing or the equivalent.

Where the imbedded arm of the connector projection 8 enters the block section 12, the size or volume of the block section of the fishing tackle knot funnel body 2 may the thickened. This will prevent tear out of the connector projection 8 as could be expected when fighting a fish. The material used for the construction of the funnel body 2 dictates the dimensions of its solid body. Where steel is used, a smaller overall dimension is adequate however, where a polymer is used with an imbedded steel article of fishing tackle, such as the split ring of the present figures, a larger dimension is necessary. Additionally, the thickness of the material will have to be selected to maintain the rigidity of the device and prevent flexing as discussed herein.

The exterior configuration of the funnel body 2 will generally be cylindrical (round or polygonal) although the ends may be planar, tapered, chamfered or rounded.

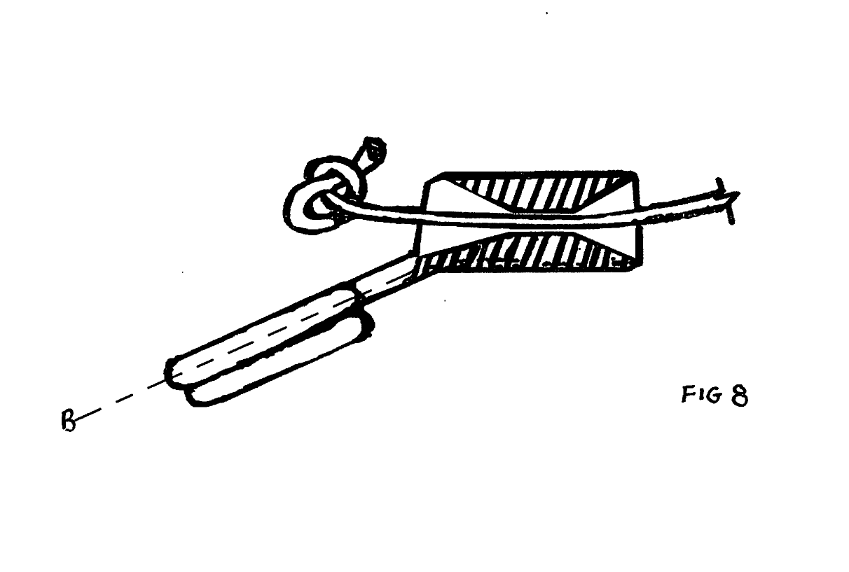

The linear axis of the block section A (FIG. 7) and the linear axis of the connector projection B (FIG. 8) are not collinear, rather they intersect in the bottom funnel 24 forming an obtuse angle there between. However, these axes are coplaner, lying in the same plane, as illustrated when viewed from above (FIG. 2). In this manner the connector projection 8 does not interfere with the feeding of the fishing line 4 through the body 2 or the tying of the knot 6 in the fishing line 4.

The connector projection 8 extends from the block section at an acute angle with respect to the linear axis A of the block section 12. This allows the user room to manipulate the fishing line 4 and more importantly, allows the connection to larger lures that may have their ring connectors far from their tip. By securing the lures at an angle to the block section 12 there is no chance of physical interference between them. This also allows the lures some freedom of movement in the water.

It can be seen that in the preferred embodiment the contiguous knot funnel (or orifice) is two mirror image right circular conical bores 22 and 24 cut into the block section 12 such that they share a common linear axis with that of the block section 12 and their circular geometrical bases lying on the opposing planar faces of the block section 12 so as to create circular entrance and exit openings and generally form an hourglass configuration with the narrowest area of the bore (the transition region 26) residing generally in the center of the block section 12.

The interior wall angle of the bottom funnel bore 24 determines how deep into the conical bore the knot 6 will reside. The transition region 26 has a diameter limited to ranges of sizes in order to work. It must be large enough to accommodate the thickness of one single strand of the fishing line 4 but yet too small to accommodate a double thickness of the same strand of fishing line 4 so that the line, when knotted once, will not pass back through. Larger diameter necks will of course accommodate all sizes of fishing lines that are able to be passed in their single strand form through the transition region 26, but will require the use of multiple knots 6 to keep the fishing line 4 from being pulled back through. This would take away from the purpose and general design of the invention, hence the reason for different sized bores to accommodate only specified diameter ranges of fishing lines.

In operation, the fishing line 4 is threaded from the top face down through the continuous bore in the block section 12, generally following along the block section's linear axis until it extends beyond the bottom face 18 and out of the bottom funnel bore 24. The fishing line 4 is tied in a simple knot 6, and then pulled back into the bottom funnel bore 24 by tension on the fishing line from the top. The simple knot compresses/tightens in on itself as it traverses along the tapered walls of the bottom funnel bore 24, stopping by abutment with the tapered side walls in the area adjacent the transition region 26. The taper of the side wall of the bottom funnel bore 24 is used to compress or tighten a simple knot in the fishing line such as a half-hitch, a slip knot, a stopper knot or an overhand knot (to name a few) by pulling on the fishing line 4 from the top. This manner of use renders the knot so compacted that there is too much frictional resistance between the sections of the fishing line that form the knot and touch each other to possibly allow the knot to come undone. The size of this compressed knot however, is too large to pass back through the transition region 26. To remove the fishing line 4, the knot 6 is pushed away from the transition region 26 past the bottom funnel bore 24 where the fishing line is cut just above the knot. The fishing line is then pulled through the transition region 26 and out past the top funnel bore 22, freeing the fishing line 4 from the funnel body 2. Since the funnel body 2 only works with a limited range of diameters of fishing lines when only one simple knot is used, different sized funnel bodies 2 may be color coded where each color represents an acceptable range for the diameters of fishing line that can be used.

When fishing line of too small a diameter is used, i.e. where it is less than half the diameter of the diameter of the transition region 26, multiple knotings may be used to increase the diameter of the overall knot such that it is too large to slip through the transition region 26 when tensioned from above. This is not the suggested or preferred method of use, but will allow the device to function.

The fishing line 4 can be removed by pushing the fishing line 4 down through the contiguous funnel bore until the fishing line 4 extends far enough beyond the block section 12 to allow it to be cut above the knot 6.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

While certain features and aspects have been described with respect to exemplary embodiments, one skilled in the art will recognize that numerous modifications are possible. For example, while not illustrated, it is known that in an alternate embodiment the top funnel bore could be eliminated and the block section 12 could have a contiguous frusticonical bore formed there through with its base at the bottom face and its apex at the top face. This would function in all aspects identical to preferred embodiment but it would require the threading of the fishing line through the opening in the top face, which is less than twice the diameter of the fishing line. This would not be a practical operation for the intended users—those with reduced dexterity in their fingers, although it is an alternate embodiment.

Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

Having thus described the invention, what is claimed as new and desired to be secured by Letters Patent is as follows:

1. An apparatus for coupling a fishing line to an item of fishing tackle comprising:
a rigid body having an orifice formed there through, said orifice having at least one frusticonical bore formed therein, said fruticonical bore having a 360 degree continuous, uninterrupted, tapered side wall; and
an openable connector extending therefrom said rigid body.

2. The apparatus for coupling a fishing line of claim 1
wherein said rigid body has a generally planar top face and a generally planar bottom face, said connector extending from once of said faces; and
wherein said orifice extends between said top face and said bottom face.

3. The apparatus for coupling a fishing line of claim 2 wherein said top face and said bottom face are generally parallel.

4. The apparatus for coupling a fishing line of claim 1 wherein said body and said orifice have a common first linear axis.

5. The apparatus for coupling a fishing line of claim 4 wherein the number of fruticonical bores formed in said orifice is two.

6. The apparatus for coupling a fishing line of claim 5 wherein said orifice is comprised of a first frusticonical bore, a second frusticonical bore, and an intermediary transitional section residing there between said first frusticonical bore and said second frusticonical bore;
wherein said first frusticonical bore, said second frusticonical bore, and said transitional section share said common linear first axis so as to give said orifice an hourglass configuration there through said body.

7. The apparatus for coupling a fishing line of claim 6 wherein said fishing line has a first diameter and said transition section has a second diameter, said second diameter greater than said first diameter yet smaller than twice said first diameter.

8. The apparatus for coupling a fishing line of claim 7 wherein said top face has an entrance opening thereon having a third diameter, and said bottom face has an exit opening thereon having a fourth diameter, said third diameter and said fourth diameter greater than twice said first diameter.

9. The apparatus for coupling a fishing line of claim 4 wherein said openable connector has a second linear axis, said second linear axis coplanar with said first linear axis but residing at an obtuse angle with respect to said first linear axis.

10. The apparatus for coupling a fishing line of claim 9 wherein said openable connector is a split ring.

11. An apparatus for coupling a fishing line to an item of fishing tackle comprising:
a non-flexible, generally cylindrical body having an hourglass configured orifice formed there through along a linear axis of said body, said orifice made of two frusticonical bores formed therein and joined at their apexes by a transition region; and
a first connector extending therefrom said rigid body;
wherein said frusticonical bores each have an uninterrupted, tapered side wall, and wherein said first connector is capable of opening and closing to connect to an opening or an engageable second connector on said fishing tackle.

12. The apparatus for coupling a fishing line of claim 11 wherein said fishing line has a first diameter and said transition section has a second diameter, said second diameter greater than said first diameter yet smaller than twice said first diameter.

13. The apparatus for coupling a fishing line of claim 12 further comprising said fishing line having said first diameter.
